(19) United States
(12) Patent Application Publication
(10) Pub. No.: US 2023/0237700 A1
(43) Pub. Date: Jul. 27, 2023

(54) SIMULTANEOUS LOCALIZATION AND MAPPING USING DEPTH MODELING

(71) Applicant: Intel Corporation, Santa Clara, CA (US)

(72) Inventors: Atul Divekar, Folsom, CA (US); Rita Chattopadhyay, Chandler, AZ (US)

(73) Assignee: Intel Corporation, Santa Clara, CA (US)

(21) Appl. No.: 18/194,338

(22) Filed: Mar. 31, 2023

Related U.S. Application Data
(60) Provisional application No. 63/326,839, filed on Apr. 2, 2022.

(51) Int. Cl. G06T 7/73; G06T 7/55

(52) U.S. Cl. CPC G06T 7/75; G06T 7/55; G06T 2207/10028; G06T 2207/30244

(57) ABSTRACT

Embodiments of localization and mapping using depth modeling are described herein. In one example, frames of image data captured by sensor(s) from various poses within an environment are received over an interface. Keypoints are detected in the current frame, and matching keypoints are found in preceding frames. The pose of the current frame is determined based at least partially on depth models associated with the matching keypoints.

### CROSS-REFERENCE TO RELATED APPLICATION

This patent application claims the benefit of the filing date of U.S. Provisional Pat. Application Serial No. 63/326,839, filed on Apr. 2, 2022, and entitled “MAPPING AND LOCALIZATION USING SURFACE SEGMENTATION AND DEPTH MODELING,” the contents of which are hereby expressly incorporated by reference.

### FIELD OF THE SPECIFICATION

This disclosure relates in general to the field of computer vision, and more particularly, though not exclusively, to simultaneous localization and mapping.

### BACKGROUND

Simultaneous localization and mapping (SLAM) enables a robot to map an unknown environment while simultaneously tracking its position within that environment. Conventional SLAM frameworks use matching keypoints identified across a sequence of camera frames to solve for the robot’s pose and environment map. For example, for each keypoint, a point in 3D space is found whose coordinates are optimized along with the camera pose so that its projection to the camera plane is as close as possible to the keypoint. As a result, each 3D point contributes three variables to the optimization problem, and since each camera frame has thousands of 3D points, the optimization problem has thousands of variables and requires significant compute resources.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures.

FIG. 1 illustrates an example of simultaneous localization and mapping (SLAM).

FIG. 2 illustrates a SLAM pipeline implemented using depth modeling in accordance with some embodiments.

FIG. 3 illustrates a flowchart for performing SLAM using depth modeling in accordance with certain embodiments.

FIGS. 4A-C illustrate an example of SLAM performed on various frames using depth modeling.

FIG. 5 illustrates an example of surface segmentation.

FIG. 6 illustrates a flowchart for performing surface segmentation in accordance with certain embodiments.

FIG. 7 illustrates an example of clustering points in an image for surface segmentation.

FIG. 8 illustrates an overview of an edge cloud configuration for edge computing.

FIG. 9 illustrates operational layers among endpoints, an edge cloud, and cloud computing environments.

FIG. 10 illustrates an example approach for networking and services in an edge computing system.

FIGS. 11A-B illustrate example embodiments of computing devices and systems.

### EMBODIMENTS OF THE DISCLOSURE

### Simultaneous Localization and Mapping (SLAM) Using Depth Modeling

Simultaneous localization and mapping (SLAM) is a method that enables an agent, such as a robot or vehicle, to map an unknown environment while simultaneously determining its pose (position and orientation) within that environment using sensors (e.g., cameras, depth sensors). Conventional SLAM frameworks (e.g., ORB-SLAM2) use matching keypoints identified across a sequence of frames to solve for the robot’s pose and environment map. This process is referred to as bundle adjustment (BA). For example, these frameworks identify matching keypoints in a sequence of frames/images captured by the robot camera, and then find an optimal solution for the camera poses and keypoint locations in 3D space, by minimizing the error between the true keypoint location in the image and the projection of the 3D point (landmark) to the estimated camera location. For example, for each keypoint, a point in 3D space referred to as a “landmark” is found whose x, y, z coordinates are optimized along with the camera pose so that its projection to the camera plane is as close as possible to the corresponding keypoint. As a result, each 3D point contributes three variables to the optimization problem, and since each scene has thousands of 3D points, the optimization problem has thousands of variables. This high-complexity optimization problem requires significant compute resources, which presents challenges for resource-constrained edge devices that need to perform SLAM in real time.

Conventional bundle adjustment techniques fail to take advantage of the structure of a scene. For example, each scene contains 3D objects, and neighboring 3D points typically belong to the same object or surface and thus have a definite relationship with each other. However, since conventional bundle adjustment techniques process each 3D point in the scene independently, they fail to leverage the relationships between neighboring points.

Thus, conventional bundle adjustment techniques have the following disadvantages: (i) the correlation between neighboring points is not used; (ii) the computational cost is high since each 3D point contributes three variables to the solution; (iii) the depth map is susceptible to noise (e.g., each point has its own depth measurement, which can be noisy); and (iv) the environment is represented using distinct points instead of surfaces or regions.

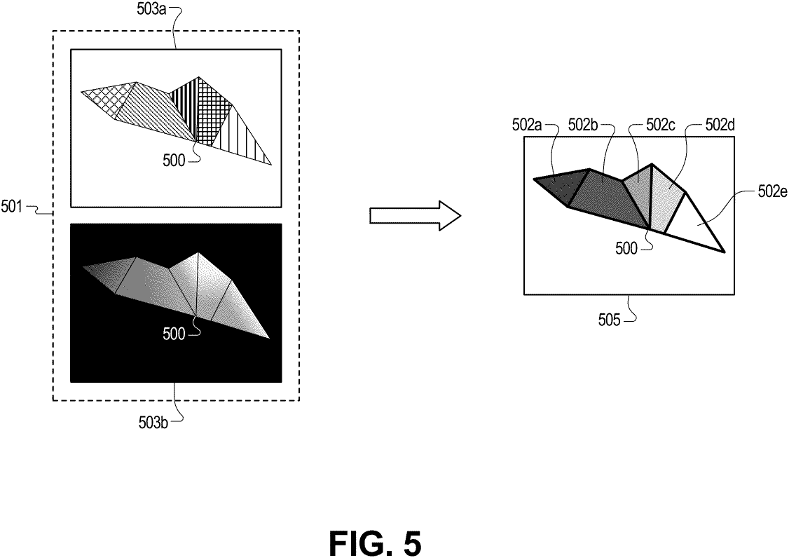

Accordingly, this disclosure presents embodiments of a SLAM framework that uses 3D regions to represent the environment map and planar models to represent the depth of object surfaces. For example, surfaces in color and depth images are segmented using a novel surface segmentation algorithm (described in connection with FIGS. 5-7), and depth values for 3D regions corresponding to the surfaces are modeled by low-order polynomials. Moreover, the polynomial coefficients are used as parameters in the bundle adjustment optimization (e.g., pose/map optimization), such that entire surfaces or regions-rather than individual points—are shifted in 3D space to fit the color and depth map data. This greatly reduces the size of the optimization problem, which increases speed and decreases estimation error (e.g., by up to 80-90% in some cases).

The 3D region representation of the environment provides a lightweight, dense, and whole-surface representation of the environment map. This allows modeling of entire surfaces in the environment, which ties together 3D landmarks in the same surface of an object and exploits their correlation. Further, this approach enables the use of reflectance properties of the facets (e.g., using the bidirectional reflectance distribution function (BRDF)), and also enables uses of the map for applications beyond SLAM.

This SLAM framework provides numerous advantages. For example, object surfaces are treated as discrete entities and entire surfaces are shifted in 3D space instead of individual points, which is a more natural (and accurate) way of treating objects. Moreover, modeling the depth of each surface is much less susceptible to noise than relying on distinct depth measurements for each individual point. The computational cost of bundle adjustment is also greatly reduced since the number of independent variables is reduced. Further, this SLAM framework unifies regularization, planar feature discovery, and optimization into a single framework. This SLAM framework is also compatible with existing state-of-the-art SLAM frameworks (e.g., ORB-SLAM2, vSLAM, etc.) and can be used to significantly improve their speed and accuracy.

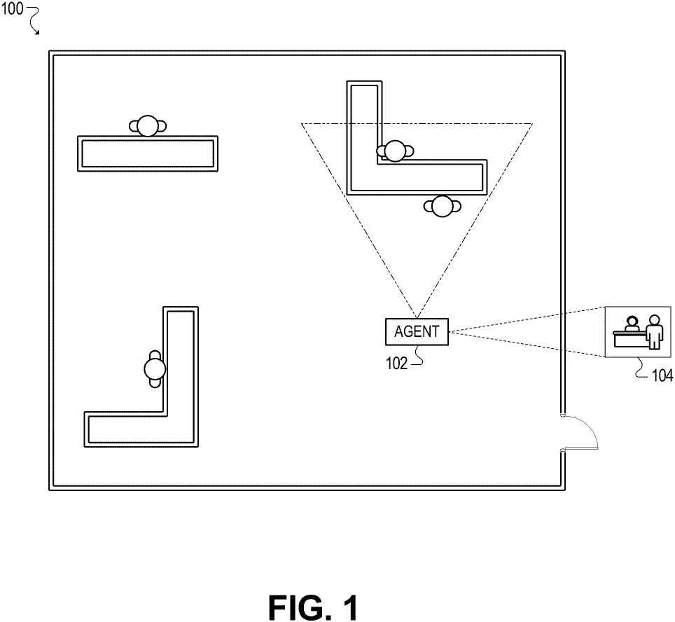

FIG. 1 illustrates an example of simultaneous localization and mapping (SLAM) in an environment 100. As discussed above, SLAM is a computational technique used in robotics and autonomous systems that enables an agent 102 to build a map of an unknown environment while simultaneously determining its position and orientation (pose) within the environment. To accomplish this, the agent 102 typically uses a combination of sensors to perceive the environment, such as cameras and distance/depth sensors (e.g., LIDAR/RADAR).

SLAM has many real-world applications, including robotics, autonomous vehicles, and augmented reality / virtual reality (AR/VR), among other examples. In various embodiments, for example, the agent 102 may be a robot, autonomous vehicle, drone, or AR/VR headset. In robotics and autonomous vehicles, SLAM can be used to enable a robot and/or vehicle to autonomously navigate through an environment, while in augmented reality, SLAM can be used to create a virtual map of the user’s environment that can be used to overlay virtual objects onto the real world.

Examples of common types of robotic agents 102 that may leverage SLAM include autonomous mobile robots (AMRs) (e.g., robots that move freely and autonomously throughout an environment, such as autonomous vehicles, drones, and robot vacuums), automated guided vehicles (AGVs) (e.g., robots that rely on tracks or predefined paths and often require operator oversight), humanoids (e.g., robots that perform human-centric functions and often take human-like forms), articulated robots (e.g., robots, also referred to as robotic arms, that are meant to emulate the functions of a human arm), collaborative robots (cobots) (e.g., robots designed to function alongside or directly with humans), and hybrid robots (e.g., combinations of the foregoing).

In the illustrated example, the agent 102 is performing SLAM in an office environment 100 by exploring or traversing the environment, capturing sensor data 104 (e.g., video/depth frames, point clouds) from different poses throughout the environment, and simultaneously tracking its pose within the environment while also mapping the environment based on the sensor data 104.

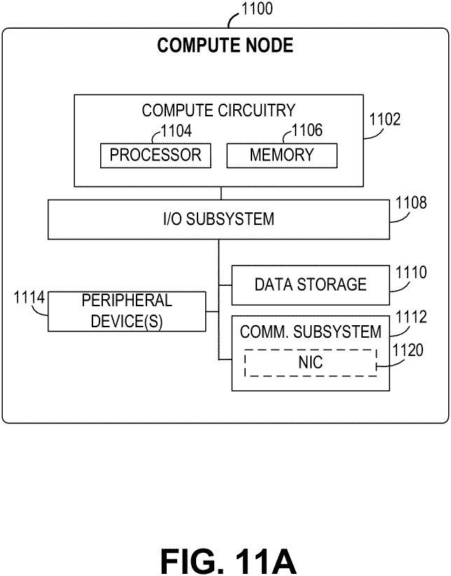

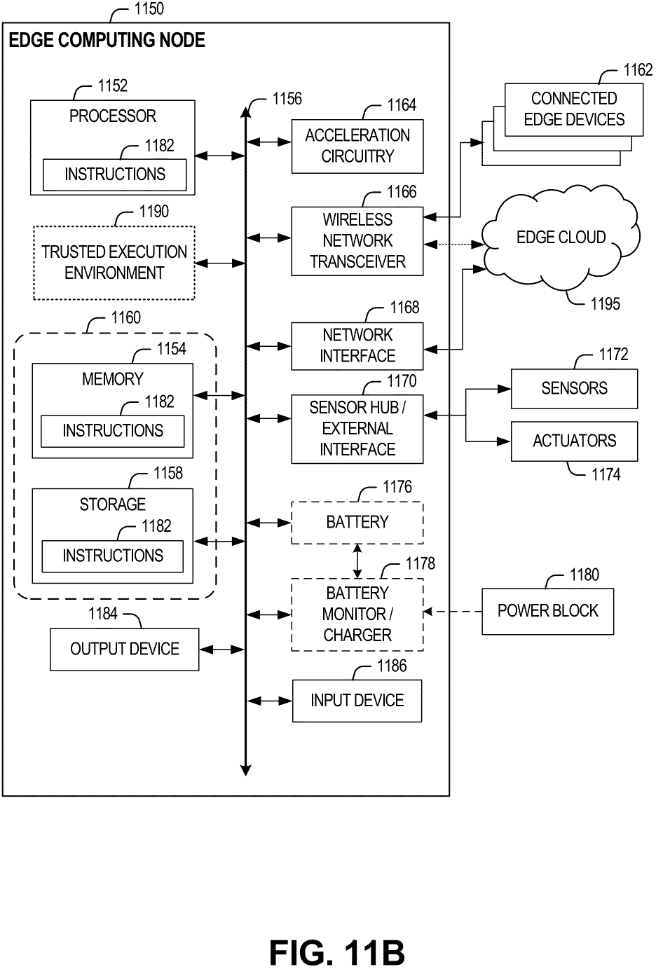

The agent 102 may include any suitable type and/or combination of computing components for performing SLAM (e.g., processors, accelerators, sensors). In some embodiments, for example, the agent 102 may include the example computing devices and systems described throughout this disclosure (e.g., compute devices 1100, 1150 and sensors 1172 of FIGS. 11A-B).

Further, in some embodiments, the agent 102 may implement SLAM using the surface segmentation and/or depth modeling techniques described throughout this disclosure.

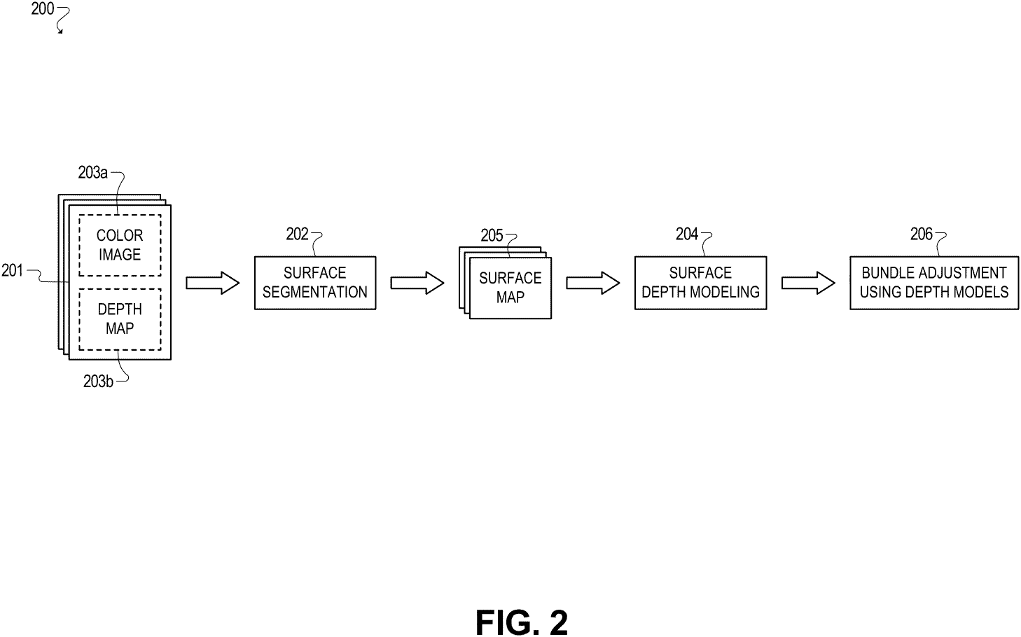

FIG. 2 illustrates a simultaneous localization and mapping (SLAM) pipeline 200 implemented using surface depth modeling in accordance with some embodiments. In the illustrated embodiment, pipeline 200 (i) represents the environment as dense three-dimensional (3D) regions; (ii) segments planar regions (e.g., surfaces) in color and depth maps using a fast novel algorithm; (iii) models depth values of the planar regions in 3D using two-dimensional (2D) polynomials; and (iv) uses the model parameters directly in bundle adjustment optimization. This approach provides numerous advantages. For example, whole surfaces are modeled with polynomials and shifted during optimization, which is a natural way to treat objects. As a result, the size of the optimization problem reduces from thousands to low hundreds of variables, which significantly speeds up the SLAM algorithm, reduces mapping error by approximately 90% compared to other SLAM frameworks (e.g., ORB-SLAM2), and provides increased robustness to noise (e.g., due to the use of polynomial depth models for entire surfaces rather than separate depth values for each individual point).

In the illustrated embodiment, a video stream containing frames 201 with color and depth information is processed through pipeline 200 and used in the bundle adjustment optimization problem. For example, each frame 201 may include a color image 203a and a corresponding depth map 203b (also referred to herein as a depth image). The color image 203a may be a 2D array of pixel colors (e.g., numerical values in red-green-blue (RGB) or YUV/YCbCr format that represent the color of each pixel), while the depth map 203b may be a 2D array of pixel depths (e.g., numerical values representing the depth of each pixel). In some embodiments, only certain frames 201 in the video stream may be processed through pipeline 200, such as those designated as keyframes.

At block 202, surface segmentation is performed on each frame 201 to segment the frame into distinct planar regions or surfaces. In some embodiments, surface segmentation may be performed using the surface segmentation algorithm described below in connection with FIGS. 5-7, which adapts DBSCAN clustering principles to images to perform surface segmentation in O(N) time by only comparing neighboring pixels in the image. The output is a surface segmentation map 205, which divides or segments the frame 201 into distinct planar regions or surfaces.

At block 204, the depth of each segmented surface identified in the surface map 205 is modeled in a 3D environment using polynomials. For example, the 2D segmented surfaces in the original frame 201 are projected into 3D space to create corresponding 3D regions in a 3D map of the environment, and 2D polynomial models are fitted to the depth values in each 3D region.

In some embodiments, depending on the complexity of a particular surface, its depth may be modeled with a zero-order, first-order, or second-order polynomial using the following example equations:

| | |
|---|---|
| zero-order polynomial: | D (x, y) ≈ c |
| first-order polynomial: | D (x, y) ≈ αx + βy + c |
| second-order polynomial: | D (x, y) ≈ αx² + βy² + cxy + dx + ey + f |

where D(x,y) is the model prediction for the depth value, or z coordinate, at the specified x and y coordinates, and the coefficients (e.g., α, β, c, ...) are the model parameters, which may be computed using a least squares fitting or any other suitable data fitting method.

In the above equations, the zero-order polynomial has one parameter (c), the first-order polynomial has three parameters (α, β, c), and the second-order polynomial has six parameters (α, β, c, d, e,f).

At block 206, bundle adjustment is performed using the depth models. Bundle adjustment is a technique used in SLAM to optimize the estimates of camera poses and 3D landmark positions, which enables a more accurate and reliable map of the environment to be created. In SLAM, these parameters are estimated from multiple observations of the environment, which are captured in certain frames designated as “keyframes.” However, these estimates are imperfect and may contain errors due to noise, uncertainty, and inaccuracies in the sensors and algorithms used to estimate them. Bundle adjustment optimizes these parameters by finding values that minimize reprojection errors, which are the errors or differences between observed 2D keypoints and projected 3D landmarks in each keyframe.

In particular, bundle adjustment is framed as a nonlinear least-squares optimization problem, where the goal is to find values for these parameters that minimize the sum of the squared reprojection errors. Bundle adjustment is an iterative process that starts with an initial estimate of the parameters and then iteratively adjusts their values to reduce the reprojection error until convergence is reached. The final estimates of the parameters are used to build the 3D map of the environment.

In conventional SLAM frameworks (e.g., ORB-SLAM2), the camera poses of keyframes, and the x, y, and z coordinates of each 3D landmark, are treated as parameters or variables that are optimized in the bundle adjustment, which results in a huge number of variables due to the typically large number of 3D landmarks.

In pipeline 200, however, the parameters of the polynomial depth models for the 3D regions (e.g., α, β, c, ...) are used directly as variables in the bundle adjustment instead of using a separate z coordinate for each 3D landmark in the region, which significantly reduces the number of variables in the optimization problem. In this manner, bundle adjustment is performed by adjusting the depth model parameters to shift entire 3D regions (e.g., surfaces) rather than individual 3D landmarks, which is significantly faster and more accurate than optimizing all three coordinates of each landmark.

This bundle adjustment framework based on depth modeling can be implemented using various optimization approaches with a tradeoff between accuracy and speed. In the first approach, the x and y coordinates of 3D landmarks remain fixed during bundle adjustment (and the depth models are used in lieu of the z coordinates), and afterwards, the x and y coordinates are separately updated based on estimates from all keyframes that each landmark is seen in. In the second approach, the x and y coordinates of 3D landmarks serve as separate variables for bundle adjustment, which are optimized along with the depth model parameters for each 3D region/surface (in lieu of the z coordinates of each landmark).

In the first approach, the inputs for bundle adjustment (BA) include six variables for each frame pose and the parameters of the surface model for each 3D region (e.g., one parameter for a zero-order model, three parameters for a first-order model, etc.). Here, the x and y coordinates of each landmark remain fixed, and BA computes optimized pose and surface model parameters. For example, for each landmark, each keyframe that the landmark is seen in is used to provide an estimate of the 3D coordinates (x, y, z) for the landmark, using the optimized pose of the keyframe and the depth map. These estimates are combined or averaged (e.g., using a mean or weighted mean calculation) to obtain a single position estimate for each landmark. For each region, the estimated coordinates of landmarks in the region are used to update the parameters of the corresponding depth model for that region. The updated landmarks and depth models are then used in the next iteration of the BA algorithm.

In the second approach, the inputs for BA include six variables for each frame pose, the parameters of the surface model for each 3D region, and the x and y coordinates of each 3D landmark. These input parameters are optimized over several iterations, and once complete, the optimized values are returned.

The first approach provides greater speed, while the second approach may provide better accuracy. For example, in the first approach, the x, y, and z coordinates of landmarks are not included in bundle adjustment, which greatly reduces the number of variables in the optimization problem compared to conventional bundle adjustment algorithms (e.g., from 10⁵ to 10²). In the second approach, the x and y coordinates of landmarks are included in bundle adjustment but the z coordinates are not, which is more accurate than the first approach at the expense of more variables and higher computational complexity, but still significantly reduces the number of variables compared to conventional bundle adjustment algorithms.

In either approach, the BA optimizer directly modifies region parameters (α, β, c, etc.) for each surface, adjusting whole surfaces to best match the image data. This is a natural way to handle objects and enforce correlations between neighboring vertices, thus essentially acting as a regularizer. Further, the least square fitting of each region’s depth values and use of model prediction provides robustness to noise present in the depth map, since depth map values are not directly used.

As a result, SLAM pipeline 200 achieves a significant reduction in mapping error compared to conventional SLAM/bundle adjustment frameworks. For example, as shown in Table 1, the pipeline 200 reduces the absolute trajectory error (ATE) and relative pose error (RPE) by 80-90% compared to conventional frameworks (e.g., ORB-SLAM2).

TABLE 1

Performance comparison for conventional SLAM versus SLAM with depth modeling

| | Conventional SLAM | SLAM with Depth Modeling |
|---|---|---|
| Mean Absolute Trajectory Error | 0.13019467 m | 0.01377667 m |
| Mean Rotational Pose Error | 5.71788778° | 0.76268529° |

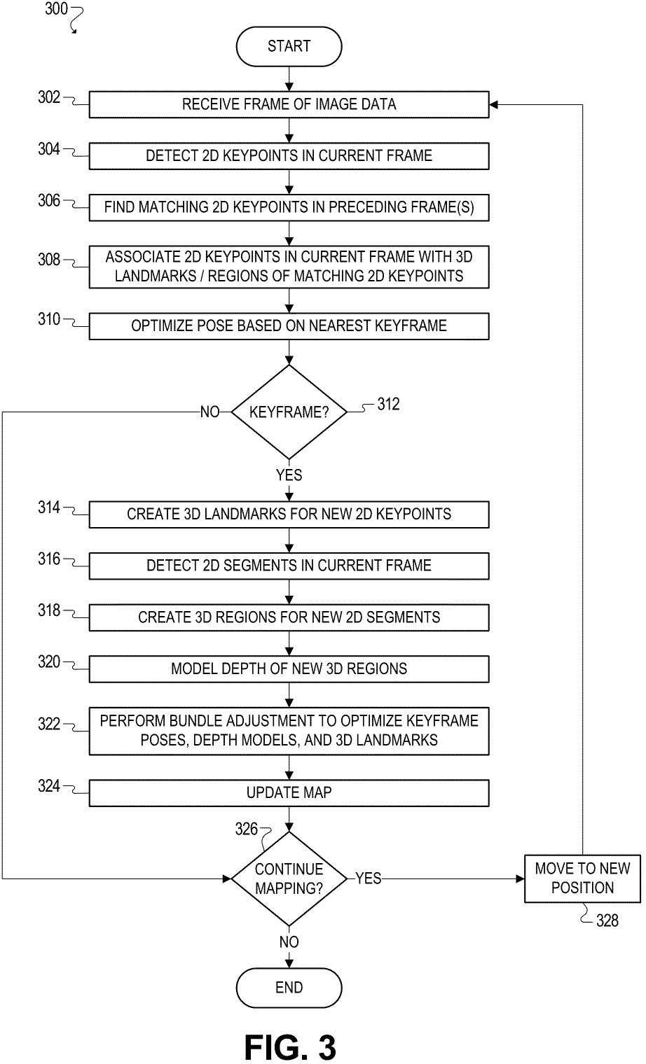

FIG. 3 illustrates a flowchart 300 for performing simultaneous localization and mapping (SLAM) using depth modeling in accordance with certain embodiments. In some embodiments, flowchart 300 may be performed by an agent (e.g., robot, vehicle, drone) using the example computing devices and systems described throughout this disclosure (e.g., compute devices 1100, 1150 of FIGS. 11A-B).

The process flow begins at block 302 by receiving a frame of image data (e.g., color/depth data) captured by one or more sensors. In some embodiments, the frame may contain color and depth information for a 2D array of pixels. For example, the frame may contain a color image and a corresponding depth map (or depth image), or the frame may contain multiple channels with color and depth values for each pixel (e.g., red, green, and blue channels with RGB color values for each pixel, and a depth channel with the corresponding depth value for each pixel).

Further, the sensors used to capture the color/depth information may include one or more imaging and/or depth sensors, such as a camera (e.g., traditional camera, depth camera, three-dimensional (3D) camera), a light detection and ranging (LIDAR) sensor, a radio detection and ranging (RADAR) sensor, an ultrasonic sensor, an infrared sensor, a thermal sensor, and/or any other type of depth/imaging sensor that uses light, radio waves, and/or sound, among other examples.

The process flow then proceeds to block 304 to detect 2D keypoints in the current frame. For example, a “keypoint” may refer to a 2D point or area in the frame that corresponds to a prominent feature, such as a corner or edge of an object or wall, among other examples. Keypoints are typically distinctive features in the frame that can be reliably detected and matched across multiple frames (e.g., even under varying lighting conditions or viewpoints), which enables them to be used as reference points to track the agent’s position within an environment.

Keypoints are typically detected and tracked using computer vision techniques, such as feature detection, feature extraction, and feature matching. Examples of algorithms that can be used for keypoint detection include, without limitation, convolution neural networks (CNNs) and other forms of artificial intelligence, scale-invariant feature transforms (SIFT), speeded-up robust features (SURF), features from accelerated segment test (FAST), KAZE, accelerated-KAZE (AKAZE), oriented fast and rotated binary robust independent elementary features (ORB), and binary robust invariant scalable keypoints (BRISK).

Once detected, a keypoint is typically represented using a numerical descriptor that captures its distinctive features, such as a feature vector with numerical or binary values representing a set of features associated with the keypoint. In this manner, keypoint descriptors can be used to match the same keypoint across multiple frames.

The process flow then proceeds to block 306 to find matching keypoints in one or more preceding frames. In some embodiments, for example, keypoints are matched across frames by comparing the keypoint descriptors from the current frame to the keypoint descriptors from one or more preceding frames, such as the nearest keyframe.

Since there are no preceding frames for the first frame of a given stream, however, blocks 306-310 of the process flow may be skipped for the first frame.

The process flow then proceeds to block 308 to associate the 2D keypoints in the current frame with 3D landmarks corresponding to the matching 2D keypoints. For example, as described below in connection with block 314, whenever a new 2D keypoint is detected in a keyframe, a 3D landmark corresponding to that keypoint is created in the 3D map of the environment. Accordingly, the keypoints in the current frame are associated with the existing 3D landmarks for the matching keypoints in preceding frames.

The process flow then proceeds to block 310 to optimize the estimated pose (position and orientation) of the current frame based on the nearest keyframe. Pose optimization is similar to the bundle adjustment process described below in connection with block 322, except the pose of the current frame is the only parameter optimized. For example, the pose of the current frame is optimized based on various parameters of the nearest keyframe, including the estimated pose, 3D landmarks, and 3D region depth models for that keyframe.

The process flow then proceeds to block 312 to determine whether the current frame should be designated as a keyframe. In some embodiments, for example, the first frame of a stream is always designated as a keyframe, and subsequent frames are selectively designated as keyframes based on various criteria. For example, the criteria may involve a specified interval (e.g., designating every X^{th} frame as a keyframe) and/or the frame content, such as a change in scene (e.g., when entering a new or unseen area of the environment), the presence of previously undetected keypoints or other features, the failure to find any matching keypoints in preceding frames, and so forth.

If the current frame is not designated as a keyframe, then processing of the current frame is complete, and the process flow proceeds to block 326 to determine whether to continue mapping the environment, as described below.

If the current frame is designated as a keyframe, the process flow proceeds to block 314, where 3D landmarks are created for any new 2D keypoints detected in the current frame (e.g., keypoints in the current frame that are not matched with any keypoints in preceding frames). For example, whenever a new 2D keypoint is detected in a keyframe, a 3D landmark corresponding to that keypoint is created in the 3D map of the environment. The 3D landmark is a 3D representation of the 2D keypoint, which is created by projecting the 2D keypoint into 3D space using the estimated pose of the keyframe and the depth value for the keypoint.

For any 2D keypoints in the current frame that are not new, those keypoints have already been matched with keypoints in preceding frames and associated with existing 3D landmarks created for the matching keypoints, as described above in connection with blocks 306-308. In this manner, matching 2D keypoints from different frames are all associated with the same 3D landmark. Further, each 3D landmark corresponds to a 2D keypoint in at least one frame and often corresponds to several 2D keypoints matched across multiple frames (up to one keypoint per frame).

The process flow then proceeds to block 316 to detect 2D segments (e.g., surfaces) in the current frame. For example, a “segment” may refer to a 2D region in the frame that contains a group of contiguous pixels, some of which may be keypoints, which is obtained as a result of a segmentation algorithm.

In some embodiments, for example, a surface segmentation algorithm (e.g., the algorithm described in connection with FIGS. 5-7) may be used to segment the current frame into distinct planar surfaces (by generating a segmentation map of planar surfaces detected in the frame). For example, rather than segmenting distinct objects in the frame, distinct surfaces of objects are segmented (e.g., floor, ceiling, walls, desk surface, desk legs, monitor screen).

The process flow then proceeds to block 318 to create 3D regions for new 2D segments. In some embodiments, for example, a 2D segment may be considered new if it only contains new 2D keypoints that are not matched with any keypoints of preceding frames (nor associated with any existing 3D landmarks/regions corresponding to those keypoints). Moreover, whenever a new 2D segment is detected in a keyframe, a 3D region corresponding to that segment is created in the 3D map of the environment. The 3D region contains the 3D landmarks corresponding to all of the 2D keypoints in the 2D segment.

For example, a “region” may refer to a 3D representation of a 2D segment in a frame, which may also match 2D segments found in other frames (e.g., up to one segment per frame). Keypoints in the same segment of the current frame (e.g., obtained by the segmentation algorithm), along with matching keypoints in other frames, are all associated with the same 3D region. Moreover, the 3D region contains 3D landmarks corresponding to all of those 2D keypoints.

In some cases, a 2D segment may be found in new frame (e.g., using the segmentation algorithm) that has only some keypoints associated with landmarks. The other (unmatched) keypoints in this segment are used to construct new landmarks, which are added to the corresponding 3D region. If a segment has no keypoints associated with landmarks, a new 3D region is constructed, and the landmarks derived from the keypoints are added to the new region.

The process flow then proceeds to block 320 to model the depth of the new 3D regions. In some embodiments, the depth of each 3D region is modeled using the coordinates of 3D landmarks within the region. For example, the x,y,z coordinates of each 3D landmark in the region may be used to create a polynomial model of the depth of the region (e.g., using a least squares fitting), such as z = D(x,y), where D is a low order polynomial with one or more coefficients or parameters.

The process flow then proceeds to block 322 to perform bundle adjustment, which optimizes the poses of keyframes, the parameters of depth models for 3D regions, and the x and y coordinates of 3D landmarks. For example, estimates of keyframes poses, depth model parameters, and x,y landmark coordinates are imperfect and may contain errors due to noise, uncertainty, and inaccuracies in the sensors and algorithms used to estimate them. Bundle adjustment optimizes these parameters by finding values that minimize reprojection errors, which are the errors or differences between observed 2D keypoints and projected 3D landmarks in each keyframe.

In particular, bundle adjustment is framed as a nonlinear least-squares optimization problem, where the goal is to find values for the keyframes poses, depth model parameters, and x,y landmark coordinates that minimize the sum of the squared reprojection errors. Bundle adjustment is an iterative process that starts with an initial estimate of these parameters and then iteratively adjusts their values to reduce the reprojection error until convergence is reached. The final estimates of the keyframe poses, depth models, and x,y landmark coordinates are used to build the 3D map of the environment.

The process flow then proceeds to block 324 to update the map of the environment based on the optimized parameters derived from the bundle adjustment (e.g., the optimized keyframes poses, depth model parameters, and x,y landmark coordinates).

The process flow then proceeds to block 326 to determine whether to continue mapping the environment. In some cases, for example, the agent may stop or pause the mapping process based on various criteria, such as the occurrence of a terminating event. For example, the terminating event may include, without limitation, finishing the map of the environment (or a particular area within the environment), completing another task that may or may not be related to mapping (e.g., vacuuming, driving to a destination), receiving a command from a user, detecting a low battery, and so forth. Thus, upon detecting a termination event, the agent may stop (or pause) mapping the environment and the process flow may be complete.

Otherwise, upon determining to continue mapping, the process flow proceeds to block 328 to move to a new position within the environment, and the process flow then cycles back through blocks 302 - 324 to continue mapping the environment at the new position. Mapping of the environment continues in this manner until a termination event is detected at block 326.

At this point, the process flow may be complete. In some embodiments, however, the process flow may restart and/or certain blocks may be repeated. For example, in some embodiments, the process flow may restart at block 302 to continue performing SLAM in the same or different environment.

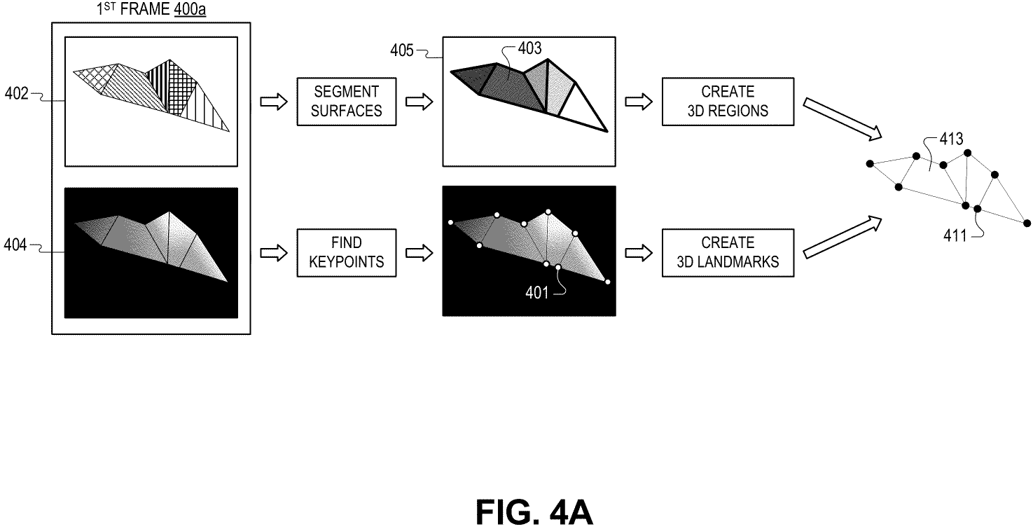

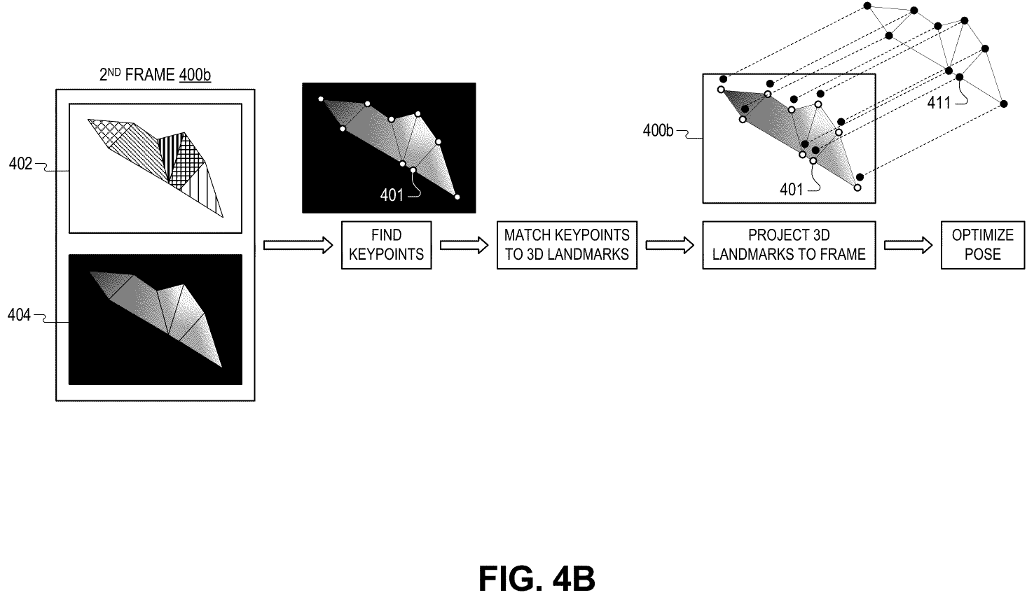

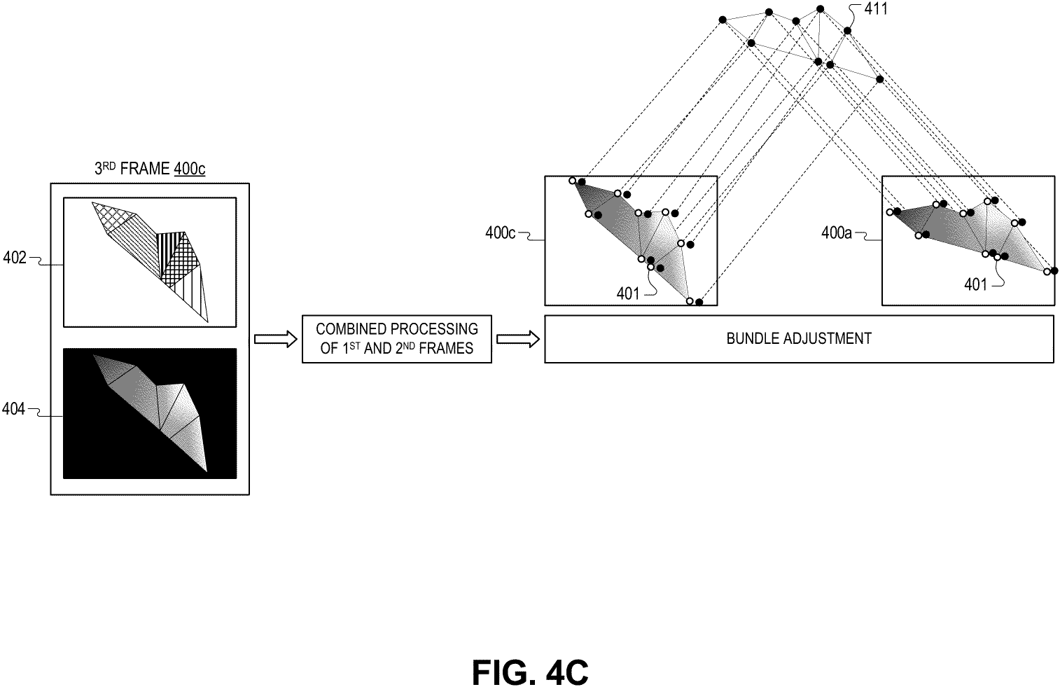

FIGS. 4A-C illustrate an example of SLAM performed on various frames using process flow 300 of FIG. 3. In the illustrated example, each frame 400a-c includes a color image 402 and a corresponding depth map 404.

The processing performed on the first frame 400a is shown in FIG. 4A. The first frame is treated as a keyframe. First, keypoints 401 are detected in the first frame 400a, and surface segmentation is performed to generate a segmentation map 405 of surfaces 403 in the first frame 400a (only select keypoints and surfaces are labeled with reference numerals for simplicity). Next, 3D landmarks 411 corresponding to the keypoints 401 are created in 3D space, and 3D regions 413 corresponding to the surface segments 403 are also created in 3D space. Further, the depth of each 3D region is modeled with a polynomial.

The processing performed on the second frame 400b is shown in FIG. 4B. The second frame is not treated as a keyframe. First, keypoints 401 are detected in the second frame, and those keypoints 401 are matched to 3D landmarks 411 corresponding to matching keypoints in the first frame (only select keypoints and landmarks are labeled with reference numerals for simplicity). The 3D landmarks 411 are projected to the second frame, and the pose of the second frame is optimized based on the error between the keypoints 401 in the second frame and the projected landmarks 411.

The processing performed on the third frame 400c is shown in FIG. 4C. The third frame is treated as a keyframe. The third frame is processed using a combination of the processing performed on the first and second frames, such as detecting keypoints and surfaces in the third frame, matching keypoints in the third frame to keypoints and 3D landmarks from other keyframes (e.g., the first frame), optimizing pose of the third frame based on projected landmarks, and creating new 3D landmarks and 3D regions for new keypoints and surfaces in the third frame. In addition, bundle adjustment is performed for the third frame to reduce the reprojection error by optimizing the poses of keyframes, the parameters of depth models for 3D regions, and the x and y coordinates of 3D landmarks.

### Surface Segmentation

Robots and other edge devices are typically memory and compute constrained. In many edge devices with cameras, image segmentation is performed to identify content in images captured by the cameras. Typically, segmentation is performed to identify each object captured in an image. In some cases, however, it may be helpful to identify each planar surface in an image, which is different than identifying entire objects that often include multiple surfaces. As an example, the simultaneous localization and mapping (SLAM) framework described above detects surfaces in images to identify groups of 3D pixels with common properties, which improves mapping. In addition, other applications may also benefit from detection of surfaces in images, including computer vision applications, object recognition, object rotation, and so forth. However, conventional segmentation methods are not suitable for performing surface segmentation in real time.

Conventional segmentation methods for surface detection include (i) applying edge detectors and finding enclosed areas and (ii) merging neighboring pixels or regions that fit a planar model until a criterion is met. These techniques have various downsides. For example, because planar regions can have large gradients (e.g., a tilted triangle with rapidly changing depth along its surface), an edge detector may incorrectly detect each pixel as an edge. In addition, a boundary between two surfaces can be smooth and have a low gradient, which is difficult for edge detectors to detect even though the surfaces are different. Further, surfaces of an object with similar texture but different orientations are not distinguished using conventional methods.

Accordingly, this disclosure presents various embodiments for performing fast and efficient surface segmentation of color and depth images, which is particularly beneficial for resource-constrained edge deployments. In particular, the described embodiments provide a fast method to segment individual surfaces (e.g., planar components) of a scene from color (e.g., red-green-blue (RGB) color)) and/or depth maps. This solution uses novel feature vectors and an unconventional clustering method that has not been used for imaging.

In particular, an efficient and accurate surface segmentation algorithm is implemented using concepts from density-based spatial clustering of applications with noise (DBSCAN). DBSCAN is a density-based clustering algorithm used for machine learning and data mining, typically in the database domain. In the described embodiments, the DBSCAN algorithm, which has O(N²) complexity, is adapted into an image processing algorithm with O(N) complexity using the neighborhood constraints of image pixels. The distance metric between pixels may be implemented using weighted color (e.g., RGB) and depth value differences along with gradient value differences. In addition, a merging algorithm may optionally be used to merge neighboring regions with similar polynomial models.

These embodiments provide numerous advantages. For example, the described segmentation algorithm enables fast detection of planar surfaces (e.g., those modeled by zero order, first order, or second order polynomials with x and y variables), and it can distinguish between surfaces with different gradients even if their texture and/or depth are similar. This segmentation algorithm also has broad applicability to many applications, including robotics, computer vision, imaging, object recognition and modeling, and so forth. Moreover, the fast O(N) performance is particularly beneficial for edge devices. In particular, the novel surface segmentation algorithm is implemented using (i) a fast O(N) clustering algorithm (not previously used in imaging) and (ii) a distance metric based on several features, including gradients, that can be easily modified for different applications. The algorithm can be performed in O(N) time on any 2D, 3D, or higher dimensional data (e.g., voxels) where clusters are connected components.

FIG. 5 illustrates an example of the surface segmentation algorithm on a synthetic object 500 with multiple surfaces. In the illustrated example, a frame 501 containing color and depth images 503a,b of the object 500 is supplied as input to the algorithm. The color image 503a may be a two-dimensional (2D) array of pixels with color values (e.g., RGB or YUV/YCbCr color values identifying the color of each pixel), while the depth image 503b may be a 2D array of pixels with depth values (e.g., numerical values identifying the depth of each pixel). In some cases, the depth image 503b may have unknown depth values for certain pixels (e.g., due to invalid depth measurements), which may be represented by pixels with values of 0 (depicted as black pixels in depth image 503b). As shown in frame 501, the respective surfaces of the object 500 have varying colors (e.g., as depicted by the patterns in color image 503a) and depths (e.g., as depicted by the shading in depth image 503b).

The output of the algorithm is a surface segmentation map 505, which identifies the respective surfaces 502a-e detected within the frame 501. In some embodiments, for example, the surface map 505 may label each pixel with the corresponding surface 502a-e to which it belongs, if any (e.g., pixels that do not belong to any of the detected surfaces may not be labeled). As shown in surface map 505, each polygonal surface 502a-e of the synthetic planar object 500 is identified.

By comparison, conventional segmentation methods typically use thresholding of gradient magnitudes followed by region filling, which does not work well for segmentation of distinct surfaces rather than entire objects. In particular, pixels in smooth planar regions with high magnitude are often incorrectly identified as border/edge pixels. Conversely, pixels at boundaries between planar regions may have low gradients and may not be properly identified as border/edge pixels. As a result, surfaces of an object may have the same texture but different gradients, yet they may not be identified as separate surfaces by conventional segmentation methods. The surface segmentation algorithm described herein is able to identify such surfaces much more accurately compared to conventional segmentation methods.

The surface segmentation algorithm takes 2D color and/or depth map images as input (e.g., from a camera and/or depth sensor) and applies DBSCAN clustering concepts to perform surface segmentation with O(N) complexity—compared to the O(N²) complexity of traditional DBCSAN algorithms—by exploiting the pixel grid structure of images.

For example, the surface segmentation algorithm treats pixels (e.g., color/depth values) in the image as points in a feature space, and the algorithm forms clusters of pixels, or points, that are spatially contiguous within the 2D image and near each other in feature space, while treating the remaining points as outliers or noise.

The algorithm takes two input parameters: a maximum distance (epsilon, eps, or ε) and a minimum number of points (MinPts). eps (ε) is a distance parameter or threshold that specifies the maximum distance in feature space between two points for them to be considered as part of the same cluster. MinPts specifies the minimum number of points required to form a cluster.

Further, for purposes of the below discussion, “neighboring points” or “neighbors” refers to points in adjacent pixel locations within the 2D image layout, while “adjacent” points refers to points that are within distance eps (ε) of each other in feature space.

First, distances are calculated between each pair of neighboring points within the image (with a cost of O(N)), and each point is classified as either a core point, a border point, or a noise point, as follows:
(i) core point: a point having at least MinPts-1 neighboring points within distance eps (ε).
(ii) border point: a point that does not qualify as a core point but is within distance eps (ε) of at least one neighbor core point.
(iii) noise point: a point that is neither a core point nor a border point.

Next, the clustering process begins by selecting an unlabeled core point p, which by definition has MinPts-1 “neighbors” q (e.g., adjacent pixels in the image) that are “adjacent” to p (e.g., within distance eps (ε) of p in feature space). Each neighbor q within distance eps (ε) of p in feature space is either a core point or a border point, and neighbors of p that are not within distance eps (ε) of p are outliers (e.g., noise). Thus, a new cluster is formed with p and its neighbors q that are within distance eps (ε)-which are either core or border points—and all points in the cluster are labeled with a corresponding cluster ID.

Further, for each neighboring core point q added to the cluster, its neighbors that are within distance eps (ε) in feature space are also added to the cluster. The cluster formation process continues in this manner until all neighbors of core points in the cluster that are within distance eps (ε) in feature space have also been added to the cluster, at which time the cluster is complete.

The next cluster is formed by selecting a new unlabeled core point p and repeating the same process, and each successive cluster is formed in this manner until no unlabeled core points remain (e.g., all core points have been added to a cluster).

This surface segmentation algorithm achieves O(N) complexity by leveraging various properties/observations associated with image pixel grids. First, neighboring pixels in an image tend to be similar and thus are likely to have a distance less than eps (ε). Next, a connected component (e.g., segmented surface) representing a single cluster can only grow by considering its immediate neighboring pixels, and thus each pixel only needs to be compared with its immediate neighbors to determine if it is a core point. As a result, distances only need to be computed between each pair of neighboring pixels in the image, which has O(N) cost. By comparison, traditional DBSCAN would require distances to be computed between every pair of pixels in the image, which has O(N²) cost.

Example pseudocode for the surface segmentation algorithm is provided below. Segment(eps, MinPts, I, D):

//input: RGB image I with 3 values per pixel, Depth image D with 1 value per pixel
//input: max distance eps, MinPts to declare core pixel
//output: Labeled segmentation map L
1. Apply Sobel filter to Depth image D to give Gradient maps Gx and Gy
2. For each pair of neighboring* pixels p, q with valid RGB, depth, gradient values:
d ← FindDistance(I(p),D(p),Gx(p),Gy(p); I(q),D(q),Gx(q),Gy(q))
if(d<eps) :
Add p into AdjacencyList(q)
Add q into AdjacencyList(p)
3. For each pixel p, set L(p) ← NotClassified
clusterId←-1
4. For each pixel p with valid depth:
if IsCorePoint(p):
clusterId ← clusterId + 1
BFS(p,clusterId)
else:
L(p) ← Noise
// Here neighboring means that pixels p and q are immediate vertical, horizontal or
diagonal neighbors in the image.
IsCorePoint(p,MinPts):
//input : point p
//output: boolean: is p a CorePoint (true) or not (false)
If (Length(AdjacencyList(p)) +1 >=MinPts) return true ; else false
FindDistance(I(p),D(p),Gx(p),Gy(p); I(q),D(q),Gx(q),Gy(q) )
//input: for points p and q, the RGB, depth and gradient values
//output: weighed distance between p and q
//I(p,0), I(p, 1), I(p,2) denote the R,G,B components of pixel p in image I
dI ← (I(p,0)-I(q,0))² + (I(p,1)-I(q,1))² + (I(p,2)-I(q,2))²
dD ← (D(p)-D(q))²
dG ← (Gx(p)-Gx(q))² + (Gy(p)-Gy(q))²
d ← 0.01 * dI + 0.05* dD + dG
return d
BFS(p,clusterId,MinPts): // breadth first search for new cluster rooted at p, with id
clusterId
//input : point p, clusterId for cluster rooted at p, MinPts
//output: none, updates LabelMap L
1. q ← CreateQueue
2. InsertAtEnd(q,p) //inserts p at end of q
3. While(q NotEmpty):
(i) v ← ExtractHead(q)
(ii) L(v) ← clusterId
(iii) if(IsCorePoint(v,MinPts)) :
For each point u in AdjacencyList(v):
If(L(u)=NotClassified)
(a) InsertAtEnd(q,u)
(b) L(u) ← InQ

In some embodiments, an optional merging step may be used to compare neighboring regions found by the above algorithm. For example, if polynomial models for the neighboring regions match or are sufficiently similar, the regions may be merged.

The Sobel filter and find distance methods are each O(N). The breadth first search (BFS) algorithm inserts each pixel into its queue at most once, hence it is O(N). This gives a total complexity of O(N), compared to the standard DBSCAN algorithm of O(N²).

In some embodiments, other search algorithms may be used instead of breadth first search (BFS), such as depth first search (DFS). In addition, the algorithm can be implemented using color, grayscale, and/or depth map images depending on what is available. For example, if only one type of image is available-such as RGB, grayscale, or depth map—the distance function can be modified to use the available image type.

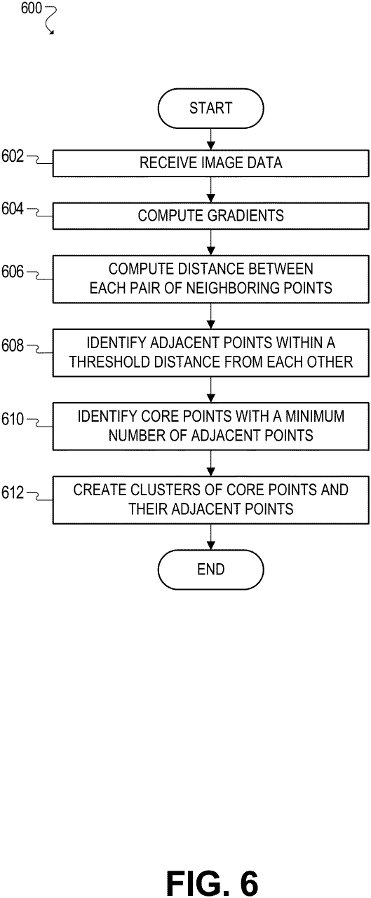

FIG. 6 illustrates a flowchart 600 for performing surface segmentation in accordance with certain embodiments. In some embodiments, flowchart 600 may be performed by an agent (e.g., robot, vehicle, drone) using the example computing devices and systems described throughout this disclosure (e.g., compute devices 1100, 1150 of FIGS. 11A-B).

The process flow begins at block 602 by receiving image data. For example, the image data may be an image or video frame that contains color and/or depth data, which may be captured by one or more sensors. In some embodiments, the sensors may include one or more imaging and/or depth sensors, such as a camera (e.g., traditional camera, depth camera, and/or three-dimensional (3D) camera), a light detection and ranging (LIDAR) sensor, a radio detection and ranging (RADAR) sensor, an ultrasonic sensor, an infrared sensor, a thermal sensor, and/or any other type of depth/imaging sensor that uses light, radio waves, and/or sound, among other examples.

The process flow then proceeds to block 604 to compute gradients for the image data. In some embodiments, for example, a Sobel filter is applied to the depth data in the horizontal (x-axis) and vertical (y-axis) directions to generate gradient maps Gₓ and G_{y}.

The process flow then proceeds to block 606 to compute the distance between each pair of neighboring points, or pixels, in the image data. In some embodiments, for example, each “point” includes a collection of feature values corresponding to a particular pixel of image data. For example, each point may include the color values (e.g., red, green, and blue color values for an RGB image), depth value, and x and y gradient values for a corresponding pixel. Further, these feature values can be used to compute the distance between two points of image data in feature space. In this context, distance may refer to an appropriate metric for quantifying the level of similarity or dissimilarity between two points based on their respective feature values. For example, a weighted distance between two points p and q can be computed based on their respective color (e.g., red, green, and blue), depth, and gradient values. Thus, in some embodiments, the distance between each pair of neighboring points in the image data is computed using the distance function.

The process flow then proceeds to block 608 to identify adjacent points that are within a threshold distance from each other in feature space. In some embodiments, for example, if the distance between a pair of neighboring points is less than a threshold distance (e.g., distance eps (ε)), those points are considered “adjacent” in feature space. Further, an adjacency list may be maintained for each point in the image, and for each pair of neighboring points that are within the threshold distance from each other, those points may be added to each other’s adjacency list.

The process flow then proceeds to block 610 to identify core points with a minimum number of “adjacent” points. In some embodiments, core points may be identified based on the number of entries in their respective adjacency lists. For example, if a point has an adjacency list with the minimum number of required points, that point may be a core point.

The process flow then proceeds to block 612 to create clusters of core points and their adjacent points. For example, each cluster is created by selecting an unlabeled core point p (e.g., a core point in the image that is not yet part of a cluster), adding core point p to a new cluster (e.g., creating a new cluster and labeling core point p with the corresponding cluster ID), and then adding the points in core point p’s adjacency list to the new cluster (e.g., labeling those points with the corresponding cluster ID).

Further, for each point q added to the cluster from core point p’s adjacency list, if q is also a core point, then the points in q’s adjacency list are also added to the cluster. For example, each point q in core point p’s adjacency list is either a core point or a border point (e.g., based on the number of points in q’s adjacency list). If q’s adjacency list has the minimum number of points required to be a core point, q is a core point, otherwise q is a border point since it is adjacent to at least one core point (e.g., core point p). If q is a core point, then q and the points in its adjacency list are added to the cluster, but if q is a border point, then q is added to the cluster but the points in its adjacency list are not. This process continues until the cluster contains all points in the adjacency lists of core points in the cluster, at which time the cluster is complete.

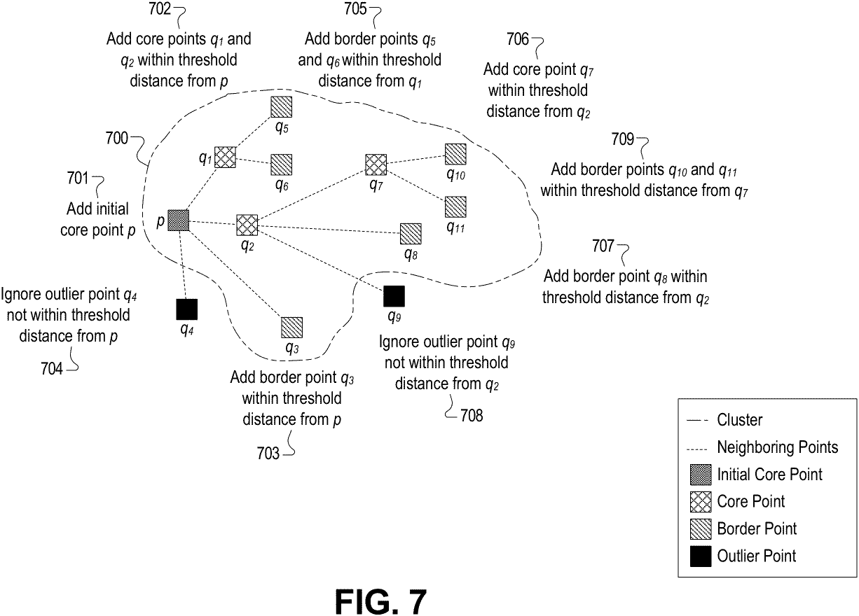

Each additional cluster is formed by selecting a new unlabeled core point p and repeating the same process until no unlabeled core points remain (e.g., all core points have been added to a cluster). An example of the clustering process is shown and described in connection with FIG. 7.

At this point, the process flow may be complete. In some embodiments, however, the process flow may restart and/or certain blocks may be repeated. For example, in some embodiments, the process flow may restart at block 602 to perform surface segmentation on another image or frame.

FIG. 7 illustrates an example of clustering for surface segmentation. In the illustrated example, a cluster 700 of points—which corresponds to a particular surface within an image—is formed using the clustering process described above (e.g., in connection with FIGS. 5-6).

At step 701, an initial (unlabeled) core point p is added to a new cluster. At step 702, core points q₁ and q₂ are added to the cluster, which are neighboring core points within a threshold distance from core point p. At step 703, border point q₃ is added to the cluster, which is a neighboring border (e.g., non-core) point within the threshold distance from core point p. At step 704, outlier point q₄ is ignored, which is a neighboring point that is not within the threshold distance from core point p.

At step 705, border points q₅ and q₆ are added to the cluster, which are neighboring border points within the threshold distance from core point q₁.

At step 706, core point q₇ is added to the cluster, which is a neighboring core point within the threshold distance from core point q₂. At step 707, border point q₈ is added to the cluster, which is a neighboring border point within the threshold distance from core point q₂. At step 708, outlier point q₉ is ignored, which is a neighboring point that is not within the threshold distance from core point q₂.

At step 709, border points q₁₀ and q₁₁ are added to the cluster, which are neighboring border points within the threshold distance from core point q₇. At this point, the cluster 700 is complete.

### Example Computing Embodiments

Examples of various computing embodiments that may be used to implement the mapping and localization and/or surface segmentation solutions described herein are provided below. In particular, any aspects of the solution described in the preceding sections may be implemented using the computing embodiments described below.

### Edge Computing

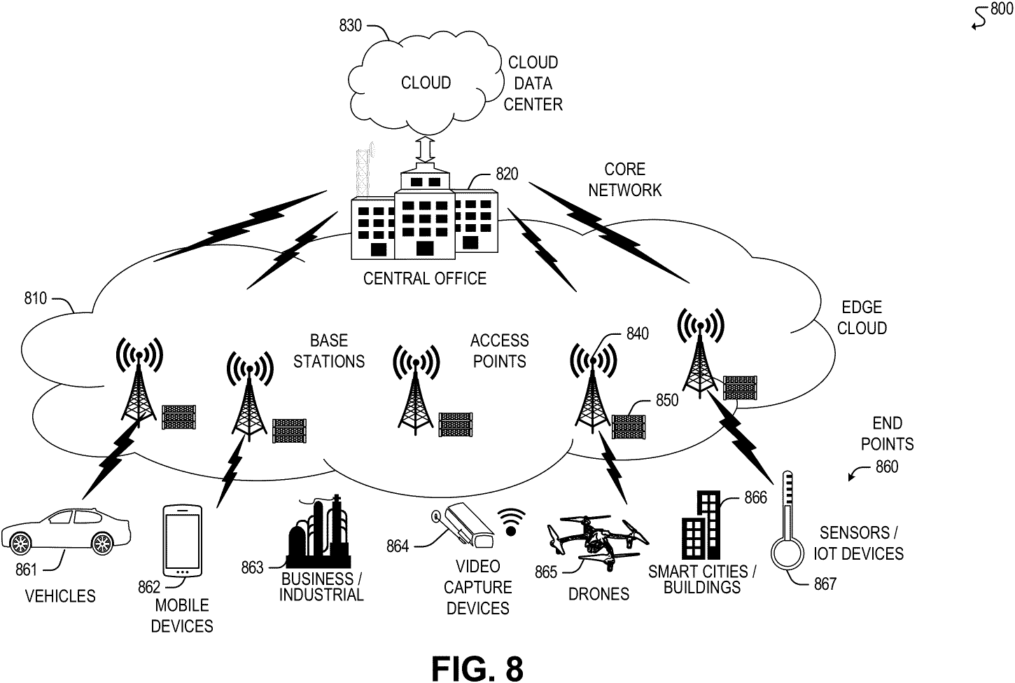

FIG. 8 is a block diagram 800 showing an overview of a configuration for edge computing, which includes a layer of processing referred to in many of the following examples as an “edge cloud”. As shown, the edge cloud 810 is co-located at an edge location, such as an access point or base station 840, a local processing hub 850, or a central office 820, and thus may include multiple entities, devices, and equipment instances. The edge cloud 810 is located much closer to the endpoint (consumer and producer) data sources 860 (e.g., autonomous vehicles 861, user equipment 862, business and industrial equipment 863, video capture devices 864, drones 865, smart cities and building devices 866, sensors and IoT devices 867, etc.) than the cloud data center 830. Compute, memory, and storage resources which are offered at the edges in the edge cloud 810 are critical to providing ultra-low latency response times for services and functions used by the endpoint data sources 860 as well as reduce network backhaul traffic from the edge cloud 810 toward cloud data center 830 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the amount of resources needed for network services, through the distribution of more resources which are located closer both geographically and in network access time. In this manner, edge computing attempts to bring the compute resources to the workload data where appropriate, or, bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge”, “close edge”, “local edge”, “middle edge”, or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data. For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services in order to scale to workload demands on an as needed basis by activating dormant capacity (subscription, capacity on demand) in order to manage corner cases, emergencies or to provide longevity for deployed resources over a significantly longer implemented lifecycle.

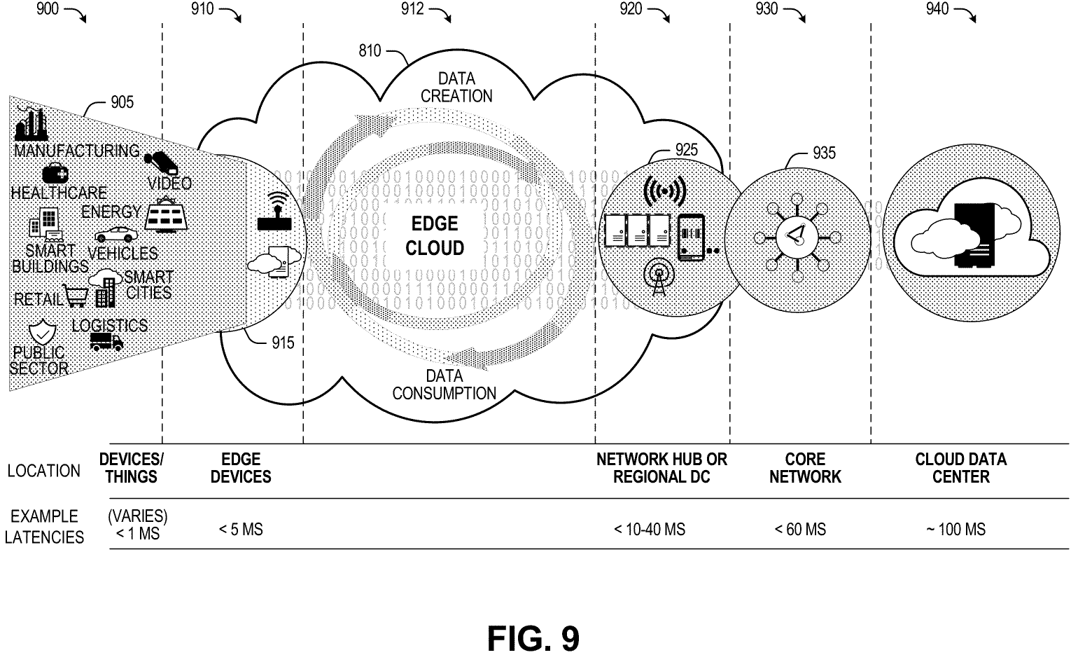

FIG. 9 illustrates operational layers among endpoints, an edge cloud, and cloud computing environments. Specifically, FIG. 9 depicts examples of computational use cases 905, utilizing the edge cloud 810 among multiple illustrative layers of network computing. The layers begin at an endpoint (devices and things) layer 900, which accesses the edge cloud 810 to conduct data creation, analysis, and data consumption activities. The edge cloud 810 may span multiple network layers, such as an edge devices layer 910 having gateways, on-premise servers, or network equipment (nodes 915) located in physically proximate edge systems; a network access layer 920, encompassing base stations, radio processing units, network hubs, regional data centers (DC), or local network equipment (equipment 925); and any equipment, devices, or nodes located therebetween (in layer 912, not illustrated in detail). The network communications within the edge cloud 810 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 900, under 5 ms at the edge devices layer 910, to even between 10 to 40 ms when communicating with nodes at the network access layer 920. Beyond the edge cloud 810 are core network 930 and cloud data center 940 layers, each with increasing latency (e.g., between 50-60 ms at the core network layer 930, to 100 or more ms at the cloud data center layer). As a result, operations at a core network data center 935 or a cloud data center 945, with latencies of at least 50 to 100 ms or more, will not be able to accomplish many time-critical functions of the use cases 905. Each of these latency values are provided for purposes of illustration and contrast; it will be understood that the use of other access network mediums and technologies may further reduce the latencies. In some examples, respective portions of the network may be categorized as “close edge”, “local edge”, “near edge”, “middle edge”, or “far edge” layers, relative to a network source and destination. For instance, from the perspective of the core network data center 935 or a cloud data center 945, a central office or content data network may be considered as being located within a “near edge” layer (“near” to the cloud, having high latency values when communicating with the devices and endpoints of the use cases 905), whereas an access point, base station, on-premise server, or network gateway may be considered as located within a “far edge” layer (“far” from the cloud, having low latency values when communicating with the devices and endpoints of the use cases 905). It will be understood that other categorizations of a particular network layer as constituting a “close”, “local”, “near”, “middle”, or “far” edge may be based on latency, distance, number of network hops, or other measurable characteristics, as measured from a source in any of the network layers 900-940.

The various use cases 905 may access resources under usage pressure from incoming streams, due to multiple services utilizing the edge cloud. To achieve results with low latency, the services executed within the edge cloud 810 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 810 may provide the ability to serve and respond to multiple applications of the use cases 905 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required, because edge locations may be unmanned and may even need permissioned access (e.g., when housed in a third-party location). Such issues are magnified in the edge cloud 810 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 810 (network layers 900-940), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 810.

As such, the edge cloud 810 is formed from network components and functional features operated by and within edge gateway nodes, edge aggregation nodes, or other edge compute nodes among network layers 910-930. The edge cloud 810 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 810 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

The network components of the edge cloud 810 may be servers, multi-tenant servers, appliance computing devices, and/or any other type of computing devices. For example, the edge cloud 810 may include an appliance computing device that is a self-contained electronic device including a housing, a chassis, a case or a shell. In some circumstances, the housing may be dimensioned for portability such that it can be carried by a human and/or shipped. Example housings may include materials that form one or more exterior surfaces that partially or fully protect contents of the appliance, in which protection may include weather protection, hazardous environment protection (e.g., EMI, vibration, extreme temperatures), and/or enable submergibility. Example housings may include power circuitry to provide power for stationary and/or portable implementations, such as AC power inputs, DC power inputs, AC/DC or DC/AC converter(s), power regulators, transformers, charging circuitry, batteries, wired inputs and/or wireless power inputs. Example housings and/or surfaces thereof may include or connect to mounting hardware to enable attachment to structures such as buildings, telecommunication structures (e.g., poles, antenna structures, etc.) and/or racks (e.g., server racks, blade mounts, etc.). Example housings and/or surfaces thereof may support one or more sensors (e.g., temperature sensors, vibration sensors, light sensors, acoustic sensors, capacitive sensors, proximity sensors, etc.). One or more such sensors may be contained in, carried by, or otherwise embedded in the surface and/or mounted to the surface of the appliance. Example housings and/or surfaces thereof may support mechanical connectivity, such as propulsion hardware (e.g., wheels, propellers, etc.) and/or articulating hardware (e.g., robot arms, pivotable appendages, etc.). In some circumstances, the sensors may include any type of input devices such as user interface hardware (e.g., buttons, switches, dials, sliders, etc.). In some circumstances, example housings include output devices contained in, carried by, embedded therein and/or attached thereto. Output devices may include displays, touchscreens, lights, LEDs, speakers, I/O ports (e.g., USB), etc. In some circumstances, edge devices are devices presented in the network for a specific purpose (e.g., a traffic light), but may have processing and/or other capacities that may be utilized for other purposes. Such edge devices may be independent from other networked devices and may be provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 11B. The edge cloud 810 may also include one or more servers and/or one or more multi-tenant servers. Such a server may include an operating system and implement a virtual computing environment. A virtual computing environment may include a hypervisor managing (e.g., spawning, deploying, destroying, etc.) one or more virtual machines, one or more containers, etc. Such virtual computing environments provide an execution environment in which one or more applications and/or other software, code or scripts may execute while being isolated from one or more other applications, software, code or scripts.

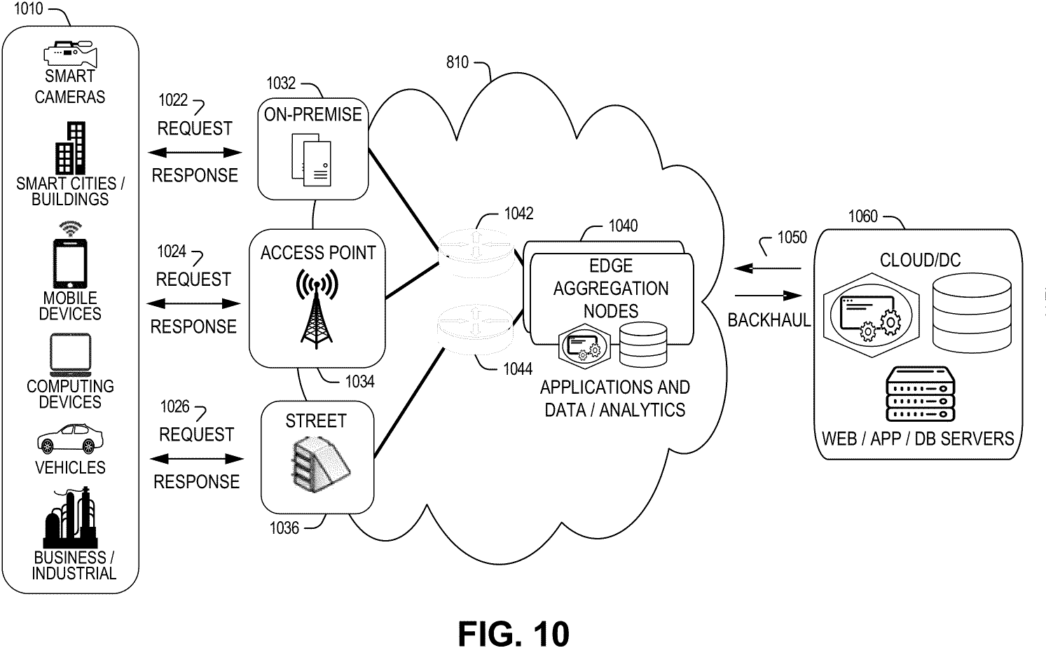

In FIG. 10, various client endpoints 1010 (in the form of smart cameras, mobile devices, computers, autonomous vehicles, business computing equipment, industrial processing equipment) exchange requests and responses that are specific to the type of endpoint network aggregation. For instance, client endpoints 1010 may obtain network access via a wired broadband network, by exchanging requests and responses 1022 through an on-premise network system 1032. Some client endpoints 1010, such as smart cameras, may obtain network access via a wireless broadband network, by exchanging requests and responses 1024 through an access point (e.g., cellular network tower) 1034. Some client endpoints 1010, such as autonomous vehicles may obtain network access for requests and responses 1026 via a wireless vehicular network through a street-located network system 1036. However, regardless of the type of network access, the TSP may deploy aggregation points 1042, 1044 within the edge cloud 810 to aggregate traffic and requests. Thus, within the edge cloud 810, the TSP may deploy various compute and storage resources, such as at edge aggregation nodes 1040, to provide requested content. The edge aggregation nodes 1040 and other systems of the edge cloud 810 are connected to a cloud or data center 1060, which uses a backhaul network 1050 to fulfill higher-latency requests from a cloud/data center for websites, applications, database servers, etc. Additional or consolidated instances of the edge aggregation nodes 1040 and the aggregation points 1042, 1044, including those deployed on a single server framework, may also be present within the edge cloud 810 or other areas of the TSP infrastructure.

### Computing Devices and Systems

In further examples, any of the compute nodes or devices discussed with reference to the present edge computing systems and environment may be fulfilled based on the components depicted in FIGS. 11A and 11B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a robot controller or compute system, a self-contained device having an outer case, shell, etc., or other device or system capable of performing the described functions.

In the simplified example depicted in FIG. 11A, an edge compute node 1100 includes a compute engine (also referred to herein as “compute circuitry” or “processing circuitry”) 1102, an input/output (I/O) subsystem 1108, data storage 1110, a communication circuitry subsystem 1112, and, optionally, one or more peripheral devices 1114. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1100 may be embodied as any type of engine, device, or collection of devices capable of performing various compute functions. In some examples, the compute node 1100 may be embodied as a single device such as an integrated circuit, an embedded system, a field-programmable gate array (FPGA), a system-on-a-chip (SOC), or other integrated system or device. In the illustrative example, the compute node 1100 includes or is embodied as a processor 1104 and a memory 1106. The processor 1104 may be embodied as any type of processor capable of performing the functions described herein (e.g., executing an application). For example, the processor 1104 may be embodied as a multi-core processor(s), a microcontroller, a processing unit, a specialized or special purpose processing unit, or other processor or processing/controlling circuit.

In some examples, the processor 1104 may be embodied as, include, or be coupled to an FPGA, an application specific integrated circuit (ASIC), reconfigurable hardware or hardware circuitry, or other specialized hardware to facilitate performance of the functions described herein. Also in some examples, the processor 704 may be embodied as a specialized x-processing unit (xPU) also known as a data processing unit (DPU), infrastructure processing unit (IPU), or network processing unit (NPU). Such an xPU may be embodied as a standalone circuit or circuit package, integrated within an SOC, or integrated with networking circuitry (e.g., in a SmartNIC, or enhanced SmartNIC), acceleration circuitry, storage devices, or AI hardware (e.g., GPUs or programmed FPGAs). Such an xPU may be designed to receive programming to process one or more data streams and perform specific tasks and actions for the data streams (such as hosting microservices, performing service management or orchestration, organizing or managing server or data center hardware, managing service meshes, or collecting and distributing telemetry), outside of the CPU or general purpose processing hardware. However, it will be understood that a xPU, a SOC, a CPU, and other variations of the processor 1104 may work in coordination with each other to execute many types of operations and instructions within and on behalf of the compute node 1100.

The memory 1106 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1106 may be integrated into the processor 1104. The memory 1106 may store various software and data used during operation such as one or more applications, data operated on by the application(s), libraries, and drivers.

The compute circuitry 1102 is communicatively coupled to other components of the compute node 1100 via the I/O subsystem 1108, which may be embodied as circuitry and/or components to facilitate input/output operations with the compute circuitry 1102 (e.g., with the processor 1104 and/or the main memory 1106) and other components of the compute circuitry 1102. For example, the I/O subsystem 1108 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1108 may form a portion of a system-on-a-chip (SoC) and be incorporated, along with one or more of the processor 1104, the memory 1106, and other components of the compute circuitry 1102, into the compute circuitry 1102.

The one or more illustrative data storage devices 1110 may be embodied as any type of devices configured for short-term or long-term storage of data such as, for example, memory devices and circuits, memory cards, hard disk drives, solid-state drives, or other data storage devices. Individual data storage devices 1110 may include a system partition that stores data and firmware code for the data storage device 1110. Individual data storage devices 1110 may also include one or more operating system partitions that store data files and executables for operating systems depending on, for example, the type of compute node 1100.

The communication circuitry 1112 may be embodied as any communication circuit, device, or collection thereof, capable of enabling communications over a network between the compute circuitry 1102 and another compute device (e.g., an edge gateway of an implementing edge computing system). The communication circuitry 1112 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1112 includes a network interface controller (NIC) 1120, which may also be referred to as a host fabric interface (HFI). The NIC 1120 may be embodied as one or more add-in-boards, daughter cards, network interface cards, controller chips, chipsets, or other devices that may be used by the compute node 1100 to connect with another compute device (e.g., an edge gateway node). In some examples, the NIC 1120 may be embodied as part of a system-on-a-chip (SoC) that includes one or more processors, or included on a multichip package that also contains one or more processors. In some examples, the NIC 1120 may include a local processor (not shown) and/or a local memory (not shown) that are both local to the NIC 1120. In such examples, the local processor of the NIC 1120 may be capable of performing one or more of the functions of the compute circuitry 1102 described herein. Additionally, or alternatively, in such examples, the local memory of the NIC 1120 may be integrated into one or more components of the client compute node at the board level, socket level, chip level, and/or other levels.

Additionally, in some examples, a respective compute node 1100 may include one or more peripheral devices 1114. Such peripheral devices 1114 may include any type of peripheral device found in a compute device or server such as audio input devices, a display, other input/output devices, interface devices, and/or other peripheral devices, depending on the particular type of the compute node 1100. In further examples, the compute node 1100 may be embodied by a respective edge compute node (whether a client, gateway, or aggregation node) in an edge computing system or like forms of appliances, computers, subsystems, circuitry, or other components.

In a more detailed example, FIG. 11B illustrates a block diagram of an example of components that may be present in an edge computing node 1150 for implementing the techniques (e.g., operations, processes, methods, and methodologies) described herein. This edge computing node 1150 provides a closer view of the respective components of node 1100 when implemented as or as part of a computing device (e.g., as a mobile device, a base station, server, gateway, etc.). The edge computing node 1150 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1150, or as components otherwise incorporated within a chassis of a larger system.

The edge computing device 1150 may include processing circuitry in the form of a processor 1152, which may be a microprocessor, a multi-core processor, a multithreaded processor, an ultra-low voltage processor, an embedded processor, an xPU/DPU/IPU/NPU, special purpose processing unit, specialized processing unit, or other known processing elements. The processor 1152 may be a part of a system on a chip (SoC) in which the processor 1152 and other components are formed into a single integrated circuit, or a single package, such as the Edison™ or Galileo™ SoC boards from Intel Corporation, Santa Clara, California. As an example, the processor 1152 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, California, a MIPS®-based design from MIPS Technologies, Inc. of Sunnyvale, California, an ARM®-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1152 and accompanying circuitry may be provided in a single socket form factor, multiple socket form factor, or a variety of other formats, including in limited hardware configurations or configurations that include fewer than all elements shown in FIG. 11B.

The processor 1152 may communicate with a system memory 1154 over an interconnect 1156 (e.g., a bus). Any number of memory devices may be used to provide for a given amount of system memory. As examples, the memory 754 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1158 may also couple to the processor 1152 via the interconnect 1156. In an example, the storage 1158 may be implemented via a solid-state disk drive (SSDD). Other devices that may be used for the storage 1158 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), antiferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1158 may be on-die memory or registers associated with the processor 1152. However, in some examples, the storage 1158 may be implemented using a micro hard disk drive (HDD). Further, any number of new technologies may be used for the storage 1158 in addition to, or instead of, the technologies described, such resistance change memories, phase change memories, holographic memories, or chemical memories, among others.

The components may communicate over the interconnect 1156. The interconnect 1156 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1156 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1156 may couple the processor 1152 to a transceiver 1166, for communications with the connected edge devices 1162. The transceiver 1166 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1162. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1166 (or multiple transceivers) may communicate using multiple standards or radios for communications at a different range. For example, the edge computing node 1150 may communicate with close devices, e.g., within about 10 meters, using a local transceiver based on Bluetooth Low Energy (BLE), or another low power radio, to save power. More distant connected edge devices 1162, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1166 (e.g., a radio transceiver) may be included to communicate with devices or services in a cloud (e.g., an edge cloud 1195) via local or wide area network protocols. The wireless network transceiver 1166 may be a low-power wide-area (LPWA) transceiver that follows the IEEE 802.15.4, or IEEE 802.15.4g standards, among others. The edge computing node 1150 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1166, as described herein. For example, the transceiver 1166 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1166 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1168 may be included to provide a wired communication to nodes of the edge cloud 1195 or to other devices, such as the connected edge devices 1162 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1168 may be included to enable connecting to a second network, for example, a first NIC 1168 providing communications to the cloud over Ethernet, and a second NIC 1168 providing communications to other devices over another type of network.

Given the variety of types of applicable communications from the device to another component or network, applicable communications circuitry used by the device may include or be embodied by any one or more of components 1164, 1166, 1168, or 1170. Accordingly, in various examples, applicable means for communicating (e.g., receiving, transmitting, etc.) may be embodied by such communications circuitry.

The edge computing node 1150 may include or be coupled to acceleration circuitry 1164, which may be embodied by one or more artificial intelligence (AI) accelerators, a neural compute stick, neuromorphic hardware, an FPGA, an arrangement of GPUs, an arrangement of xPUs/DPUs/IPU/NPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. These tasks also may include the specific edge computing tasks for service management and service operations discussed elsewhere in this document.

The interconnect 1156 may couple the processor 1152 to a sensor hub or external interface 1170 that is used to connect additional devices or subsystems. The devices may include sensors 1172, such as camera sensors, depth sensors, optical light sensors, temperature sensors, global navigation system (e.g., GPS) sensors, accelerometers, level sensors, flow sensors, pressure sensors, barometric pressure sensors, and the like. The hub or interface 1170 further may be used to connect the edge computing node 1150 to actuators 1174, such as power switches, valve actuators, an audible sound generator, a visual warning device, and the like.

In some optional examples, various input/output (I/O) devices may be present within or connected to, the edge computing node 1150. For example, a display or other output device 1184 may be included to show information, such as sensor readings or actuator position. An input device 1186, such as a touch screen or keypad may be included to accept input. An output device 1184 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1150. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1176 may power the edge computing node 1150, although, in examples in which the edge computing node 1150 is mounted in a fixed location, it may have a power supply coupled to an electrical grid, or the battery may be used as a backup or for temporary capabilities. The battery 1176 may be a lithium ion battery, or a metal-air battery, such as a zinc-air battery, an aluminum-air battery, a lithium-air battery, and the like.

A battery monitor/charger 1178 may be included in the edge computing node 1150 to track the state of charge (SoCh) of the battery 1176, if included. The battery monitor/charger 1178 may be used to monitor other parameters of the battery 1176 to provide failure predictions, such as the state of health (SoH) and the state of function (SoF) of the battery 1176. The battery monitor/charger 1178 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1178 may communicate the information on the battery 1176 to the processor 1152 over the interconnect 1156. The battery monitor/charger 1178 may also include an analog-to-digital (ADC) converter that enables the processor 1152 to directly monitor the voltage of the battery 1176 or the current flow from the battery 1176. The battery parameters may be used to determine actions that the edge computing node 1150 may perform, such as transmission frequency, mesh network operation, sensing frequency, and the like.

A power block 1180, or other power supply coupled to a grid, may be coupled with the battery monitor/charger 1178 to charge the battery 1176. In some examples, the power block 1180 may be replaced with a wireless power receiver to obtain the power wirelessly, for example, through a loop antenna in the edge computing node 1150. A wireless battery charging circuit, such as an LTC4020 chip from Linear Technologies of Milpitas, California, among others, may be included in the battery monitor/charger 1178. The specific charging circuits may be selected based on the size of the battery 1176, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1158 may include instructions 1182 in the form of software, firmware, or hardware commands to implement the techniques described herein. Although such instructions 1182 are shown as code blocks included in the memory 1154 and the storage 1158, it may be understood that any of the code blocks may be replaced with hardwired circuits, for example, built into an application specific integrated circuit (ASIC).

In an example, the instructions 1182 provided via the memory 1154, the storage 1158, or the processor 1152 may be embodied as a non-transitory, machine-readable medium 1160 including code to direct the processor 1152 to perform electronic operations in the edge computing node 1150. The processor 1152 may access the non-transitory, machine-readable medium 1160 over the interconnect 1156. For instance, the non-transitory, machine-readable medium 1160 may be embodied by devices described for the storage 1158 or may include specific storage units such as optical disks, flash drives, or any number of other hardware devices. The non-transitory, machine-readable medium 1160 may include instructions to direct the processor 1152 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1182 on the processor 1152 (separately, or in combination with the instructions 1182 of the machine readable medium 1160) may configure execution or operation of a trusted execution environment (TEE) 1190. In an example, the TEE 1190 operates as a protected area accessible to the processor 1152 for secure execution of instructions and secure access to data. Various implementations of the TEE 1190, and an accompanying secure area in the processor 1152 or the memory 1154 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1150 through the TEE 1190 and the processor 1152.

### Examples

Illustrative examples of the technologies described throughout this disclosure are provided below. Embodiments of these technologies may include any one or more, and any combination of, the examples described below. In some embodiments, at least one of the systems or components set forth in one or more of the preceding figures may be configured to perform one or more operations, techniques, processes, and/or methods as set forth in the following examples.

Example 1 includes at least one non-transitory machine-readable storage medium having instructions stored thereon, wherein the instructions, when executed on processing circuitry, cause the processing circuitry to: receive, via interface circuitry, a plurality of frames of image data, wherein the frames are captured by one or more sensors from a plurality of poses within an environment, and wherein the frames include a current frame and one or more preceding frames; detect one or more keypoints in the current frame; find one or more matching keypoints in the one or more preceding frames, wherein the one or more matching keypoints match the one or more keypoints in the current frame, and wherein the one or more matching keypoints are associated with one or more depth models of the environment; and determine, based at least in part on the one or more depth models, a pose of the current frame within the environment.

Example 2 includes the storage medium of Example 1, wherein: the one or more matching keypoints correspond to one or more landmarks in the environment; the one or more landmarks are in one or more regions of the environment; and the one or more regions are modeled by the one or more depth models.

Example 3 includes the storage medium of Example 2, wherein the instructions further cause the processing circuitry to: detect one or more surfaces in the one or more preceding frames; identify the one or more regions of the environment corresponding to the one or more surfaces; and generate the one or more depth models of the one or more regions.

Example 4 includes the storage medium of any of Examples 2-3, wherein the instructions that cause the processing circuitry to find the one or more matching keypoints in the one or more preceding frames further cause the processing circuitry to: identify the one or more landmarks corresponding to the one or more matching keypoints; and associate the one or more keypoints in the current frame with the one or more landmarks.

Example 5 includes the storage medium of any of Examples 2-4, wherein the instructions that cause the processing circuitry to determine, based at least in part on the one or more depth models, the pose of the current frame within the environment further cause the processing circuitry to: compute the pose of the current frame based at least in part on: a pose of a keyframe, wherein the keyframe is one of the preceding frames; the one or more landmarks; and the one or more depth models.

Example 6 includes the storage medium of any of Examples 2-5, wherein the instructions that cause the processing circuitry to determine, based at least in part on the one or more depth models, the pose of the current frame within the environment further cause the processing circuitry to: adjust at least some of the following values to minimize a projection error: poses of keyframes, wherein the keyframes include the current frame and at least one of the preceding frames; parameters of the one or more depth models; and coordinates of the one or more landmarks.

Example 7 includes the storage medium of any of Examples 1-6, wherein the one or more depth models comprise one or more polynomials, wherein the one or more polynomials model a depth of one or more regions of the environment.

Example 8 includes the storage medium of Example 7, wherein the one or more polynomials comprise at least one of a zero-order polynomial, a first-order polynomial, or a second-order polynomial.

Example 9 includes the storage medium of any of Examples 1-8, wherein the image data comprises color data and depth data.

Example 10 includes a device, comprising: interface circuitry; and processing circuitry to: receive, via the interface circuitry, a plurality of frames of image data, wherein the frames are captured by one or more sensors at a plurality of positions in an environment, and wherein the frames include a current frame and one or more preceding frames; detect one or more keypoints in the current frame; find one or more matching keypoints in the one or more preceding frames, wherein the one or more matching keypoints match the one or more keypoints in the current frame, and wherein the one or more matching keypoints are associated with one or more depth models of the environment; and determine, based at least in part on the one or more depth models, a position in the environment from which the current frame was captured.

Example 11 includes the device of Example 10, wherein: the one or more matching keypoints correspond to one or more landmarks in the environment; the one or more landmarks are in one or more regions of the environment; and the one or more regions are modeled by the one or more depth models.

Example 12 includes the device of Example 11, wherein the processing circuitry is further to: detect one or more surfaces in the one or more preceding frames; identify the one or more regions of the environment corresponding to the one or more surfaces; and generate the one or more depth models of the one or more regions.

Example 13 includes the device of any of Examples 11-12, wherein the processing circuitry to find the one or more matching keypoints in the one or more preceding frames is further to: identify the one or more landmarks corresponding to the one or more matching keypoints; and associate the one or more keypoints in the current frame with the one or more landmarks.

Example 14 includes the device of any of Examples 11-13, wherein the processing circuitry to determine, based at least in part on the one or more depth models, the position in the environment from which the current frame was captured is further to: compute a pose of the current frame based at least in part on: a pose of a keyframe, wherein the keyframe is one of the preceding frames; the one or more landmarks; and the one or more depth models.

Example 15 includes the device of any of Examples 11-14, wherein the processing circuitry to determine, based at least in part on the one or more depth models, the position in the environment from which the current frame was captured is further to: adjust at least some of the following values to minimize a projection error: poses of keyframes, wherein the keyframes include the current frame and at least one of the preceding frames; parameters of the one or more depth models; and coordinates of the one or more landmarks.

Example 16 includes the device of any of Examples 10-15, wherein the one or more depth models comprise one or more polynomials, wherein the one or more polynomials model a depth of one or more regions of the environment.

Example 17 includes the device of Example 16, wherein the one or more polynomials comprise at least one of a zero-order polynomial, a first-order polynomial, or a second-order polynomial.

Example 18 includes the device of any of Examples 10-17, wherein the image data comprises color data and depth data.

Example 19 includes the device of Example 18, wherein the one or more sensors comprise: a camera to capture the color data; and a depth sensor to capture the depth data.

Example 20 includes the device of any of Examples 10-19, wherein the device is implemented in a robot, a drone, or a vehicle.

Example 21 includes a method, comprising: receiving a plurality of frames of image data, wherein the frames are captured by one or more sensors from a plurality of poses within an environment, and wherein the frames include a current frame and one or more preceding frames; detecting one or more keypoints in the current frame; finding one or more matching keypoints in the one or more preceding frames, wherein the one or more matching keypoints match the one or more keypoints in the current frame, and wherein the one or more matching keypoints are associated with one or more depth models of the environment; and determining, based at least in part on the one or more depth models, a pose of the current frame within the environment.

Example 22 includes the method of Example 21, wherein: the one or more matching keypoints correspond to one or more landmarks in the environment; the one or more landmarks are in one or more regions of the environment; and the one or more regions are modeled by the one or more depth models.

Example 23 includes the method of Example 22, further comprising: detecting one or more surfaces in the one or more preceding frames; identifying the one or more regions of the environment corresponding to the one or more surfaces; and generating the one or more depth models of the one or more regions.

Example 24 includes the method of any of Examples 22-23, wherein determining, based at least in part on the one or more depth models, the pose of the current frame within the environment comprises: computing the pose of the current frame based at least in part on: a pose of a keyframe, wherein the keyframe is one of the preceding frames; the one or more landmarks; and the one or more depth models.

Example 25 includes the method of any of Examples 22-24, wherein determining, based at least in part on the one or more depth models, the pose of the current frame within the environment comprises: adjusting at least some of the following values to minimize a projection error: poses of keyframes, wherein the keyframes include the current frame and at least one of the preceding frames; parameters of the one or more depth models; and coordinates of the one or more landmarks.

While the concepts of the present disclosure are susceptible to various modifications and alternative forms, specific embodiments thereof have been shown by way of example in the drawings and are described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one of A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on one or more transitory or non-transitory machine-readable (e.g., computer-readable) storage media, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

1. At least one non-transitory machine-readable storage medium having instructions stored thereon, wherein the instructions, when executed on processing circuitry, cause the processing circuitry to:
receive, via interface circuitry, a plurality of frames of image data, wherein the frames are captured by one or more sensors from a plurality of poses within an environment, and wherein the frames include a current frame and one or more preceding frames;
detect one or more keypoints in the current frame;
find one or more matching keypoints in the one or more preceding frames, wherein the one or more matching keypoints match the one or more keypoints in the current frame, and wherein the one or more matching keypoints are associated with one or more depth models of the environment; and
determine, based at least in part on the one or more depth models, a pose of the current frame within the environment.

2. The storage medium of claim 1, wherein:
the one or more matching keypoints correspond to one or more landmarks in the environment;
the one or more landmarks are in one or more regions of the environment; and
the one or more regions are modeled by the one or more depth models.

3. The storage medium of claim 2, wherein the instructions further cause the processing circuitry to:
detect one or more surfaces in the one or more preceding frames;
identify the one or more regions of the environment corresponding to the one or more surfaces; and
generate the one or more depth models of the one or more regions.

4. The storage medium of claim 2, wherein the instructions that cause the processing circuitry to find the one or more matching keypoints in the one or more preceding frames further cause the processing circuitry to:
identify the one or more landmarks corresponding to the one or more matching keypoints; and
associate the one or more keypoints in the current frame with the one or more landmarks.

5. The storage medium of claim 2, wherein the instructions that cause the processing circuitry to determine, based at least in part on the one or more depth models, the pose of the current frame within the environment further cause the processing circuitry to:
compute the pose of the current frame based at least in part on:
a pose of a keyframe, wherein the keyframe is one of the preceding frames;
the one or more landmarks; and
the one or more depth models.

6. The storage medium of claim 2, wherein the instructions that cause the processing circuitry to determine, based at least in part on the one or more depth models, the pose of the current frame within the environment further cause the processing circuitry to:
adjust at least some of the following values to minimize a projection error:
poses of keyframes, wherein the keyframes include the current frame and at least one of the preceding frames;
parameters of the one or more depth models; and
coordinates of the one or more landmarks.

7. The storage medium of claim 1, wherein the one or more depth models comprise one or more polynomials, wherein the one or more polynomials model a depth of one or more regions of the environment.

8. The storage medium of claim 7, wherein the one or more polynomials comprise at least one of a zero-order polynomial, a first-order polynomial, or a second-order polynomial.

9. The storage medium of claim 1, wherein the image data comprises color data and depth data.

10. A device, comprising:
interface circuitry; and
processing circuitry to:
receive, via the interface circuitry, a plurality of frames of image data, wherein the frames are captured by one or more sensors at a plurality of positions in an environment, and wherein the frames include a current frame and one or more preceding frames;
detect one or more keypoints in the current frame;
find one or more matching keypoints in the one or more preceding frames, wherein the one or more matching keypoints match the one or more keypoints in the current frame, and wherein the one or more matching keypoints are associated with one or more depth models of the environment; and
determine, based at least in part on the one or more depth models, a position in the environment from which the current frame was captured.

11. The device of claim 10, wherein:
the one or more matching keypoints correspond to one or more landmarks in the environment;
the one or more landmarks are in one or more regions of the environment; and
the one or more regions are modeled by the one or more depth models.

12. The device of claim 11, wherein the processing circuitry is further to:
detect one or more surfaces in the one or more preceding frames;
identify the one or more regions of the environment corresponding to the one or more surfaces; and
generate the one or more depth models of the one or more regions.

13. The device of claim 11, wherein the processing circuitry to find the one or more matching keypoints in the one or more preceding frames is further to:
identify the one or more landmarks corresponding to the one or more matching keypoints; and
associate the one or more keypoints in the current frame with the one or more landmarks.

14. The device of claim 11, wherein the processing circuitry to determine, based at least in part on the one or more depth models, the position in the environment from which the current frame was captured is further to:
compute a pose of the current frame based at least in part on:
a pose of a keyframe, wherein the keyframe is one of the preceding frames;
the one or more landmarks; and
the one or more depth models.

15. The device of claim 11, wherein the processing circuitry to determine, based at least in part on the one or more depth models, the position in the environment from which the current frame was captured is further to:
adjust at least some of the following values to minimize a projection error:
poses of keyframes, wherein the keyframes include the current frame and at least one of the preceding frames;
parameters of the one or more depth models; and
coordinates of the one or more landmarks.

16. The device of claim 10, wherein the one or more depth models comprise one or more polynomials, wherein the one or more polynomials model a depth of one or more regions of the environment.

17. The device of claim 16, wherein the one or more polynomials comprise at least one of a zero-order polynomial, a first-order polynomial, or a second-order polynomial.

18. The device of claim 10, wherein the image data comprises color data and depth data.

19. The device of claim 18, wherein the one or more sensors comprise:
a camera to capture the color data; and
a depth sensor to capture the depth data.

20. The device of claim 10, wherein the device is implemented in a robot, a drone, or a vehicle.

21. A method, comprising:
receiving a plurality of frames of image data, wherein the frames are captured by one or more sensors from a plurality of poses within an environment, and wherein the frames include a current frame and one or more preceding frames;
detecting one or more keypoints in the current frame;
finding one or more matching keypoints in the one or more preceding frames, wherein the one or more matching keypoints match the one or more keypoints in the current frame, and wherein the one or more matching keypoints are associated with one or more depth models of the environment; and
determining, based at least in part on the one or more depth models, a pose of the current frame within the environment.

22. The method of claim 21, wherein:
the one or more matching keypoints correspond to one or more landmarks in the environment;
the one or more landmarks are in one or more regions of the environment; and
the one or more regions are modeled by the one or more depth models.

23. The method of claim 22, further comprising:
detecting one or more surfaces in the one or more preceding frames;
identifying the one or more regions of the environment corresponding to the one or more surfaces; and
generating the one or more depth models of the one or more regions.

24. The method of claim 22, wherein determining, based at least in part on the one or more depth models, the pose of the current frame within the environment comprises:
computing the pose of the current frame based at least in part on:
a pose of a keyframe, wherein the keyframe is one of the preceding frames;
the one or more landmarks; and
the one or more depth models.

25. The method of claim 22, wherein determining, based at least in part on the one or more depth models, the pose of the current frame within the environment comprises:
adjusting at least some of the following values to minimize a projection error:
poses of keyframes, wherein the keyframes include the current frame and at least one of the preceding frames;
parameters of the one or more depth models; and
coordinates of the one or more landmarks.
